(19) United States
(12) Patent Application Publication
(10) Pub. No.: US 2014/0044543 A1
(43) Pub. Date: Feb. 13, 2014

(54) HYDRAULIC TURBINE AND HYDROELECTRIC POWER PLANT

(71) Applicant: Jouni Jokela, Frutigen (CH)

(72) Inventor: Jouni Jokela, Frutigen (CH)

(21) Appl. No.: 14/113,544

(22) PCT Filed: Apr. 27, 2012
(86) PCT No.: PCT/EP12/57870

§ 371 Date: Oct. 23, 2013

(30) Foreign Application Priority Data
Apr. 27, 2011 (CH) 00717/11

(51) Int. Cl. F01D 1/26; F03B 3/08

(52) U.S. Cl. CPC F01D 1/26; F03B 3/08
USPC 416/128

(57) ABSTRACT

The present disclosure relates to a turbine for hydraulic power generation comprising two bladed wheels (11, 12, 31, 32) successively arranged in a turbine tube section (10, 21) as a fore wheel (11, 31) and an after wheel (12, 32) with respect to the water flow direction (23) along a common rotation axis (30) extending in the water flow direction (23), the wheels (11, 12, 31, 32) being configured to rotate in opposite directions driven by the water flow, and to a corresponding hydroelectric power plant. In order to improve the turbine characteristics for hydraulic power generation, in particular in view of low head power generation, the invention suggests that a first gear (46) and a second gear (47) are arranged along the rotation axis (30), each connected to a wheel (11, 12, 31, 32) and mutually connected via an engagement gearing (48) such that the fore wheel (11, 31) and the after wheel (12, 32) are coupled to each other with respect to their rotation speed, the engagement gearing (48) being connectable to a power generator.

The invention relates to a turbine for hydraulic power generation comprising two bladed wheels successively arranged in a turbine tube section as a fore wheel and an after wheel with respect to the water flow direction along a common rotation axis extending in the water flow direction. The wheels are configured to rotate in opposite directions driven by the water flow. The invention also relates to a hydroelectric power plant in a flowing or falling water comprising such a turbine.

Hydraulic turbines are used for the production of electrical power by converting the energy of a water flow offered from water falling or flowing through the gravitational force. The hydraulic head and the rate of the water flow are determining parameters. Current low head hydraulic turbines use a fall of water of less than 20 meters, often less than 5 meters, for power production.

Concerns remain about the environmental impact of low head hydropower applications. Large construction sizes of low head dams, weirs, drop structures as well as large water energy dissipaters and velocity controllers to ensure erosion control lead to a disturbance of a natural and paddler safe river environment and of fish migration. Indeed, it would be highly desirable to harness low head hydropower without the need of separate fish-ladder constructions and a division of the main flow for a bedload transportation past the hydroelectric power plant, such that the fish and residual water could pass alongside the turbine.

French patent application FR 2 787 522 refers to a power generator employing an aerodynamic and also a liquid current flow. To this end, at least one bladed rotor wheel is arranged in a housing traversed by the current flow. A fixed rotation speed is imposed on the wheel by an external regulation means, such as a regulated mechanical brake or electric brake or flap gate, to achieve a current flow speed at the exit of the housing that corresponds to 1/√3 of the current flow speed at the housing entry. In one embodiment, two rotor wheels with an opposed rotation direction are successively arranged in the housing, each comprising a separate brake and operating independent of each other. By the external regulation of the rotation speed of the wheels, however, aerodynamic power gets lost.

International patent application WO 2006/016360 A2 describes a device enabling a rotor and a stator to rotate in opposite directions which can be used for generation of electrical power. To this end, a generator is arranged in between the rotor and the stator along the rotation axis such that the rotor and stator can rotate independently. The arrangement is disposed in a water flow pipe formed of concrete at the bottom of a dam with a cross-sectional area narrowing in the water flow direction. The device is not well suited for low head hydropower applications.

British patent application GB 1,132,117 discloses a speed increaser for an axial flow hydraulic turbine. To this end, the power turbine wheel has blades which are radially shorter than the inner diameter of the surrounding housing and which are provided with an inner shroud to provide an annular passage between the shroud and the turbine housing. Where a relatively high ratio of speed increase is required, contra-rotating pairs of freely rotating bladed wheels are provided in the turbine housing. Such an arrangement can lead to large construction sizes and a sacrifice of turbine efficiency due to the shortened turbine blades cannot be fully avoided.

It is an object of the present invention to remedy at least one of the above mentioned deficiencies and to provide the initially addressed turbine with an improved performance characteristics for hydraulic power generation. It is another object of the invention to allow a reduction of the construction size required for such a turbine and/or for a corresponding hydroelectric power plant comprising at least one such turbine. It is a further object of the invention to provide the turbine with the capability to be used in a hydroelectric power plant working with a comparatively low or very low head.

At least one of these objects is attained by the turbine according to claim 1 and the hydroelectric power plant according to claim 19. The dependent claims define preferred embodiments.

Accordingly, in a turbine according to the invention, a first gear and a second gear are arranged along the rotation axis, wherein the first gear is connected to the fore wheel and the second gear is connected to the after wheel such that each of the first and second gear is configured to rotate around the rotation axis driven by the respective wheel. The first gear and the second gear are connected via an engagement gearing such that the fore wheel and the after wheel are coupled to each other with respect to their rotation speed, wherein the engagement gearing is connectable to a power generator.

Thus, due to the connection of the first gear and the second gear via the engagement gearing, a drivenly fixed connection between the fore wheel and the after wheel can be established, in which the relative rotation speed of the wheels is synchronized according to a predetermined ratio. In this way, a more reliable running performance of the turbine can be achieved, wherein an advantageous feedback between the wheels is preferably provided to a certain extent via the engagement gearing.

As a further advantage, the nominal rotation speed of the wheels can be effectively reduced for extracting a desired power output. Thus, a higher friendliness to living water organisms can be provided due to a more peacefully changing water pressure which may be combined with a more open inner tube structure.

Moreover, an advantageous power extraction from the turbine can be provided, in which both wheels can equally contribute to the power generation. Furthermore, the engagement gearing allows to feed the power extracted from both wheels to a single generator. In particular, small output powers delivered from a single wheel can thus be advantageously enhanced by the contribution of the second wheel to sufficiently supply the generator.

it is to be noted that in the context of the present patent application, the term “water flow” can refer to the movement of flowing and of falling water.

For power extraction, the engagement gearing is preferably fixed to a transmission shaft for connecting the engagement gearing to the power generator, wherein the transmission shaft extends through an outer wall of the turbine tube section or of a tube section before or behind the turbine tube section. In this way, all kinds of power generators regardless the respective sizes can be disposed externally with an arbitrary lateral distance to the water flow. It is also conceivable, however, to provide the power generator before or behind the water flow tube comprising the turbine tube section. It is further conceivable to provide the power generator and its connection to the engagement gearing inside the turbine tube section or a tube section further upstream or downstream.

To drive the gear arrangement, the first gear is preferably connected to the fore wheel via a first shaft and the second gear is preferably connected to the after wheel via a second shaft, wherein one of the shafts is a hollow shaft and the other shaft extends concentrically through the hollow shaft along the rotation axis. In this way, the gears can be advantageously provided at any position along the rotation axis and the wheel and gear design and location can be chosen to minimize the disturbance to the water flow. For this purpose, the first gear and the second gear are preferably disposed downstream with respect to the location of both wheels. A gear arrangement upstream with respect to the location of the wheels is also conceivable. A gear location in between the wheels is further conceivable, wherein both shafts can be arranged in a mutually opposed manner and no hollow shaft is needed. Preferably, the gears are successively arranged along the rotation axis. More preferred, the gears are arranged in a mutually opposing manner on the rotation axis.

According to a preferred embodiment, the engagement gearing is constituted by a single gear, in particular a conical gear, that is preferably disposed in between the first gear and the second gear. This allows a direct power extraction from the turbine and losses can be minimized. According to another preferred embodiment, the engagement gearing is constituted by a gearing assembly comprising several gears. This can be used, for instance, for a power extraction from a turbine in which the rotation speed of the wheels is synchronized to a value differing from each other, i.e. to a rotation speed ratio that is not equal to one. This can also be used to provide a desired transformation ratio of the rotation speed to a generator.

In order to allow a synchronized running of the wheels, the geometry of the turbine tube section and/or the wheels is preferably adapted to produce a desired ratio of the relative rotation speed of the wheels. In a preferred embodiment, the turbine tube section and/or the wheels are configured in such a way that the fore wheel and the after wheel can be driven by the water flow at substantially the same rotation speed. In this way, a stable running of the wheels and good power extraction can be accomplished. However, other ratios of the rotation speed are also conceivable. Moreover, various measures are conceivable to adapt the turbine tube section and/or the wheels accordingly. Some preferred measures are summarized below.

Preferably, the turbine tube section is provided with an inside diameter increasing in the water flow direction. In this way, the kinetic energy of the water can be lowered already inside the turbine tube section in which the bladed wheels are provided. In consequence, the dimensioning of a draft tube section that is needed to reduce the water flow speed behind the turbine tube section can be effectively reduced. Moreover, due to the increasing tube diameter, the flow area through the after wheel is preferably increased with respect to the flow area through the fore wheel. By an increase of the respective flow area, the rotation speed of the after wheel can be approached to a desired rotation speed of the fore wheel to avoid scarifying of output power or turbine efficiency.

Preferably, the change of the inside diameter of the turbine tube section is chosen such that the water flow speed is reduced by at least 6%, more preferred by at least 20%, at the cross-sectional area at which the water flow exits the after wheel as compared to the cross-sectional area at which the water flow enters the fore wheel. In particular, an optimum turbine performance could be demonstrated in a preferred configuration which comprises a change of the inside diameter of the turbine tube section such that a decrease of the water flow speed of in between 40% to 60% is achieved at the cross-sectional area at which the water flow exits the after wheel as compared to the cross-sectional area at which the water flow enters the fore wheel. The water flow speed is preferably defined as the average of the velocity profile of the water passing through the respective cross-sectional area.

A particularly efficient reduction of the water velocity inside the turbine tube section combined with a synchronization of the rotation speed of the wheels can be achieved when the inside diameter of the turbine tube section increases with a slope continuously increasing from the position at which the water flow enters the fore wheel to the position at which the water flow exits the after wheel. More preferred, the inner side wall of the turbine tube section exhibits a convex curvature along which the cross-sectional area widens in the water flow direction.

Preferably, the size and shape of the wheel blades is adapted to the inner wall geometry of the turbine tube section, such that the outer edges of the blades are substantially directly adjoining to the inner wall of the turbine tube section. Thus, the turbine efficiency can be maximized.

Preferably, the fore wheel or the after wheel or both have a diameter at a leading edge at which the water flow enters the wheel which is smaller as compared to the diameter at a leaving edge at which the water flow exits the respective wheel. This can further contribute to a synchronization of the rotation speed of the wheels. More preferred, the difference between the leaving edge diameter and the leading edge diameter of the after wheel is larger as compared to the difference between the leaving edge diameter and the leading edge diameter of the fore wheel.

Preferably, the diameter of the fore wheel comprises a value in between 60% to 97% of the diameter of the after wheel to achieve synchronization of the rotation speed of the wheels. According to a preferred configuration, the leading edge diameter of the fore wheel is at most 97%, more preferred at most 90% and most preferred at most 80%, of the leaving edge diameter of the after wheel. According to a specific example, an optimum turbine performance could be shown in a preferred configuration which comprises an increase in diameter of the leaving edge of the after wheel as compared to the leading edge of the fore wheel of in between 65% to 75%.

Preferably, both wheels are arranged along the rotation axis before or after the gears with respect to the water flow direction. The fore wheel and the after wheel are preferably arranged in immediate proximity to each other, in particular such that the leaving edge of the fore wheel is substantially directly followed by the leading edge of the after wheel. In this way, the turbine efficiency can be further improved and misrouted currents or leakage currents at an intermediate volume or disruption between the wheels can be avoided. Preferably, the leaving edge diameter of the fore wheel substantially corresponds to the leading edge diameter of the after wheel.

According to a preferred configuration, an equal number of blades is provided on the fore wheel as compared to the number of blades on the after wheel. According to another preferred configuration, a different number of blades is provided on the fore wheel as compared to the after wheel. More preferred, the blade number on the fore wheel is larger as compared to the blade number on the after wheel. According to a specific example, one additional blade is preferably provided on the fore wheel. In particular, four blades in total are preferably provided on the fore wheel and three blades in total are preferably provided on the after wheel.

Preferably, the length in the water flow direction of the after wheel is different than the length in the water flow direction of the fore wheel. In this way, the rotation speed of the after wheel can be approached to a desired rotation speed of the fore wheel according to a desired output power or turbine efficiency. Preferably, the length of the after wheel differs from the length of the fore wheel by at least 5%, more preferred at least 10%, of its length. Thereby, different wheel configurations are conceivable.

According to a preferred configuration, the fore wheel exhibits a larger length in the water flow direction as compared to the after wheel. Such a wheel configuration can be advantageous to balance the energy of the fore wheel and after wheel transmitted from the water flow to a desired value, in particular to an equal value. Such a wheel configuration is preferably employed when an equal number of blades is provided on the fore wheel as compared to the after wheel.

According to another preferred configuration, the after wheel exhibits a larger length in the water flow direction as compared to the fore wheel. Such a wheel configuration can be advantageous to extend the length of the after wheel in order to provide a desired value of pitch of the wheel blades with respect to a line perpendicular to the rotation axis at the leaving edge of the after wheel. Such a wheel configuration is preferably employed when a larger number of blades is provided on the fore wheel as compared to the after wheel.

Preferably, the pitch of the wheel blades, in particular with respect to a defined flow line of the water flow, decreases in the water flow direction. Thereby, a continuously decreasing pitch angle with respect to the plane of rotation of the wheels is preferably provided in the water flow direction. Preferably, the radius corresponding to the pitch of the wheel blades, in particular with respect to a defined flow line of the water flow, increases in the water flow direction. Thereby, a shape of the wheel blades, in particular along a defined flow line of the water flow, is preferred which corresponds to a fractional revolution of a helix with a diameter increasing in the water flow direction and/or a pitch angle decreasing in the water flow direction. These measures can also be used for a synchronization of the rotation speed of the wheels.

Preferably, the course of the wheel blades around the hub of the fore wheel is continued correspondingly by the course of the wheel blades around the hub of the after wheel, in particular with respect to the pitch of the blades and/or the corresponding pitch radius.

An advantageous combination of two or more of the above described measures is preferably applied on the turbine tube section and/or the wheels inside to simultaneously allow synchronization of the rotation speed of the wheels, a stable running of the wheels and optimization of the power output and/or turbine efficiency.

The turbine according to the invention may be also described as an “axial turbine” comprising a rotation axis of the wheels extending in the water flow direction while nonetheless allowing to exploit a change of velocity of the water flow for energy generation. Up to now, a working principle based on a velocity change of the water jet is only known from impulse turbines in which, however, the rotation axis of the wheels must be arranged perpendicular to the water flow. On the other hand, a rotation axis of the wheels extending in the water flow direction is currently only used in reaction turbines which are based, however, on a differing working principle in which the velocity of the water flow remains unchanged.

The upstream end of the turbine tube section is preferably defined as a position at which the water flow enters the fore wheel or as a position further upstream. Before the upstream end, the turbine tube section is preferably adjoined by an entry tube section through which the water flow is delivered to the turbine tube section, wherein the entry tube section preferably exhibits a narrowing diameter in the water flow direction to increase the kinetic energy of the water flow.

The downstream end of the turbine tube section is preferably defined as a position at which the water flow exits the after wheel. At the downstream end, the turbine tube section is preferably adjoined by a draft tube section that is used to recover the kinetic energy. To this purpose, the draft tube section is preferably provided with an inside diameter increasing in the water flow direction and a length adapted to recover the water flow speed downstream of the turbine to a level of the water flow speed upstream of the turbine.

According to a preferred configuration, the length of the draft tube section corresponds to a value of at most four times the diameter of the fore wheel at a leading edge at which the water flow enters the wheel. Thus, above described technical features of the turbine according to the invention can be effectively exploited to reduce the size that is necessary for the draft tube section to substantially achieve full recovery of the kinetic energy of the water flow.

A hydroelectric power plant according to the invention comprises a flowing or falling water and at least one turbine according to the foregoing description, wherein the flowing or falling water is channeled through the turbine tube section. Preferably, the hydroelectric power plant is installed in a flowing water, in particular a natural or artificial river environment.

In a preferred configuration of the power plant, the flowing or falling water exhibits a hydraulic head of at most 4 m, more preferred at most 2.5 m and most preferred 0.8 m, before entering the turbine tube section. More preferred, due to above described technical features of the turbine according to the invention allowing to employ a hydraulic head that can be substantially below 1 m, no separate fish-ladder constructions and no division of the main flow are necessary and provided in such a power plant. Moreover, such a power plant is preferably provided with a trashrack that is mainly cleaned by the residual water flow. Thus, the hydroelectric power plant can advantageously be constructed without a separate mechanical trashrack cleaning machine.

Further embodiments of the invention include a hydraulic machine having two plurality bladed wheels which rotate in opposite directions in the same rotation axis, placed on the water flow as a fore wheel and as an after wheel in a way where these wheels affect the flow of each other optimizing their functionality. Preferably, the fore wheel has more or an equal amount of blades as the after wheel. Preferably, the fore wheel has a smaller diameter than the after wheel. Preferably, the fore wheel has a different pitch and/or pitch diameter than the after wheel. Preferably, at least one or both of the wheels have a smaller leading edge diameter and a greater leaving edge diameter. Preferably, the leaving edge diameter of the fore wheel is equal to the leading edge diameter of the after wheel. Preferably, the two plurality bladed wheels have a driveable fixed connection between each other. Preferably, the machine transfers the mechanical energy outside the water flow with a shaft. Preferably, the machine is installed into a tube in a way where the water flow speed is reduced also in the bladed wheel area together with the after tube area.

The invention is explained in more detail hereinafter by means of preferred embodiments with reference to the drawings which illustrate further properties and advantages of the invention. The figures, the description, and the claims comprise numerous features in combination that one skilled in the art may also contemplate separately and use in further appropriate combinations. In the drawings:

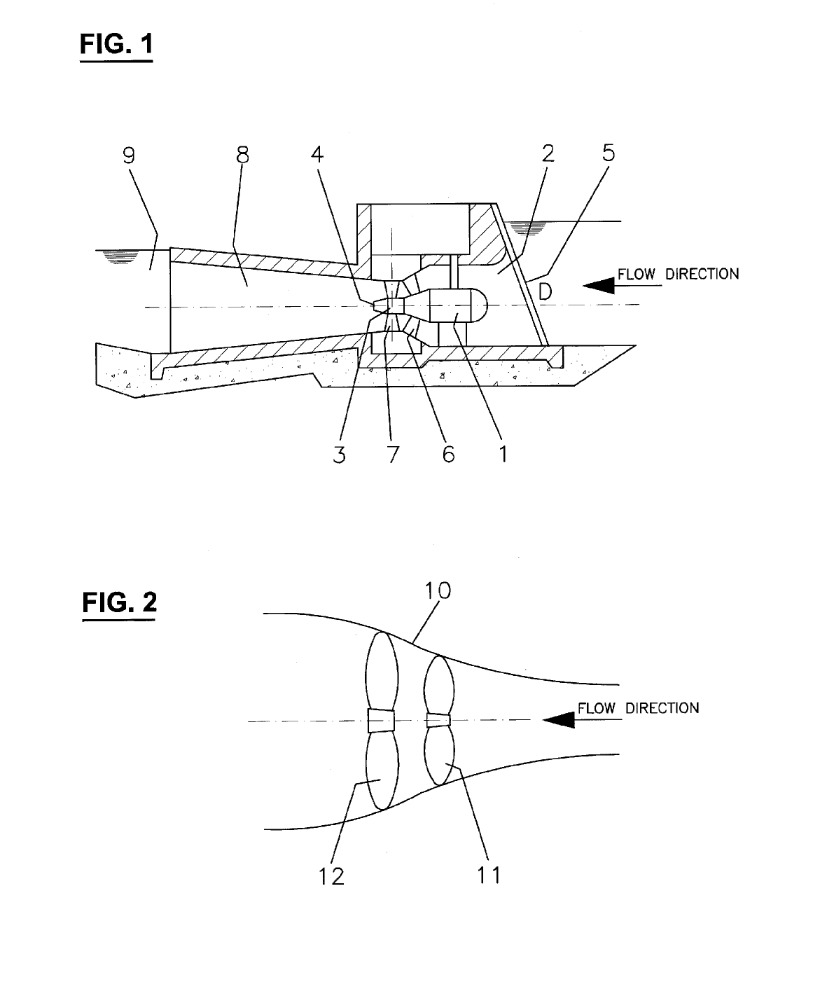

FIG. 1 is a longitudinal sectional view of a conventional hydraulic turbine installation;

FIG. 2 is a schematic representation of a turbine according to the invention;

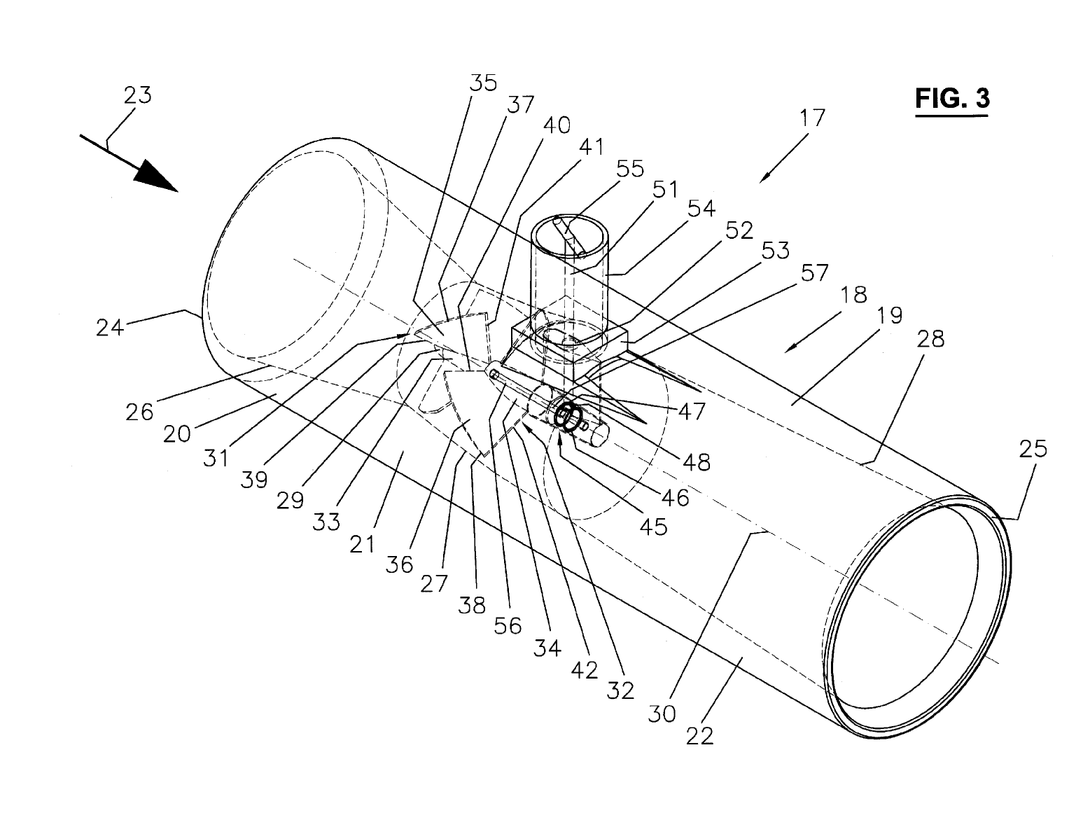

FIG. 3 is a perspective view of a turbine according to the invention;

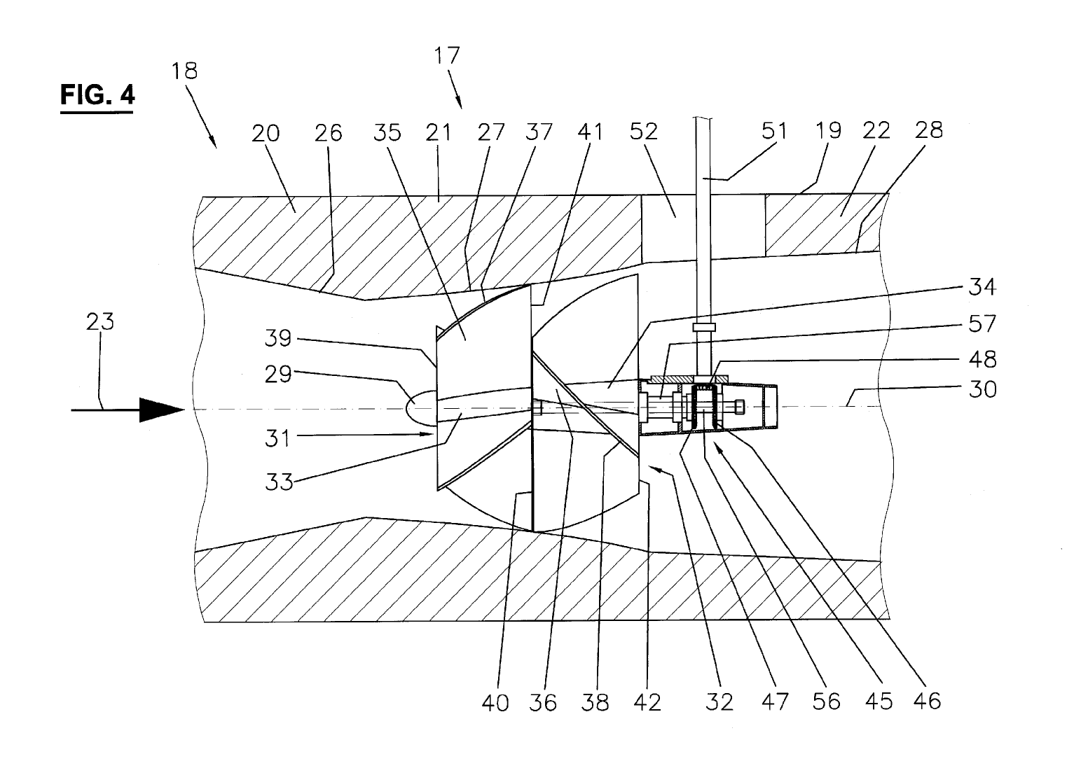

FIG. 4 is a longitudinal sectional view of a turbine according to the invention;

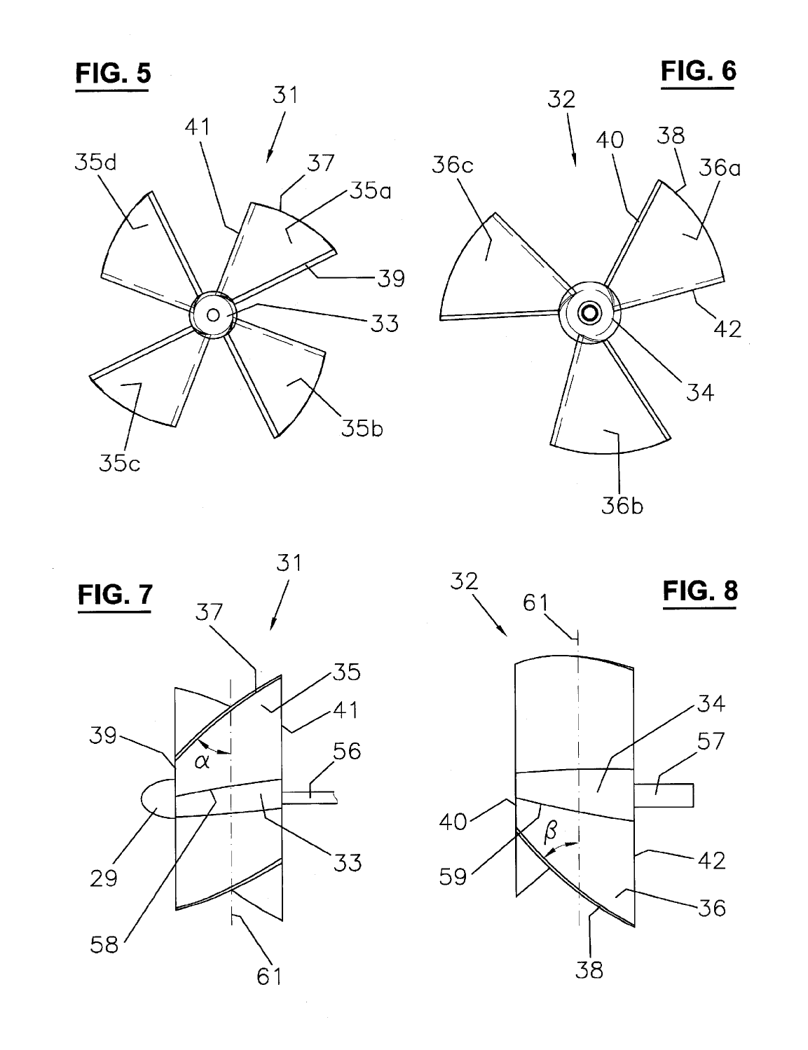

FIG. 5 is a frontal view of a fore wheel of the turbine shown in FIG. 3 and FIG. 4;

FIG. 6 is a frontal view of an after wheel of the turbine shown in FIG. 3 and FIG. 4;

FIG. 7 is a side view of the fore wheel shown in FIG. 5;

FIG. 8 is a side view of the after wheel shown in FIG. 6;

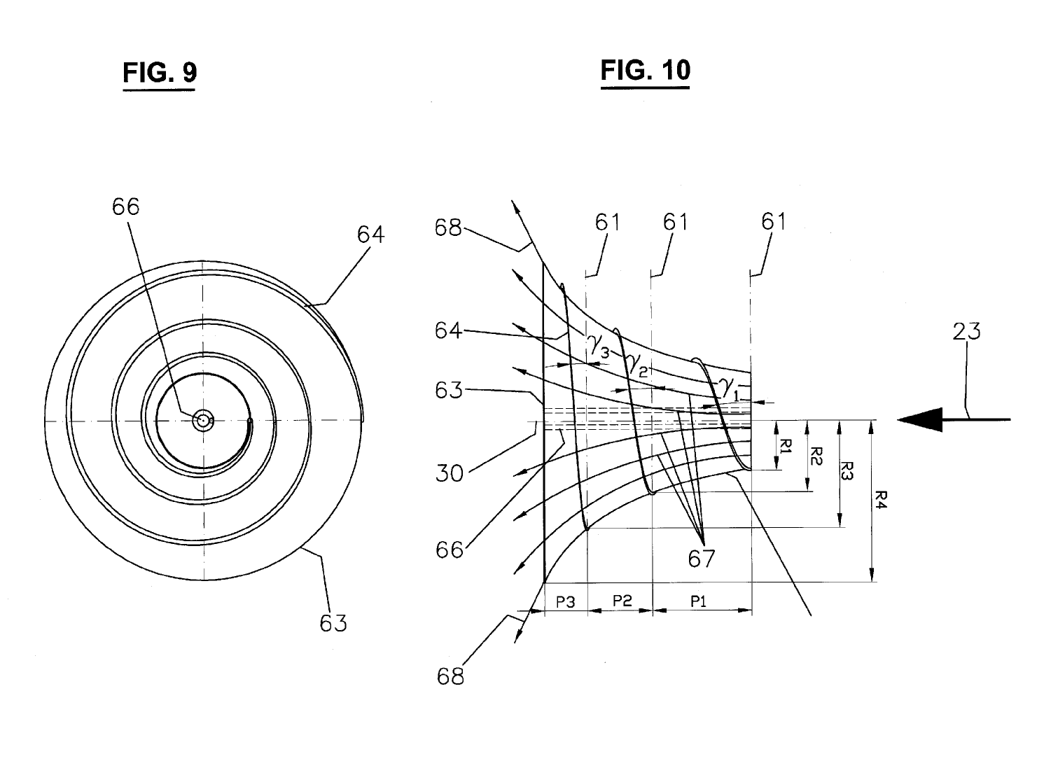

FIG. 9 is a frontal view of a wheel hub illustrating a preferred wheel geometry according to the invention;

FIG. 10 is a side view of the wheel hub shown in FIG. 9; and

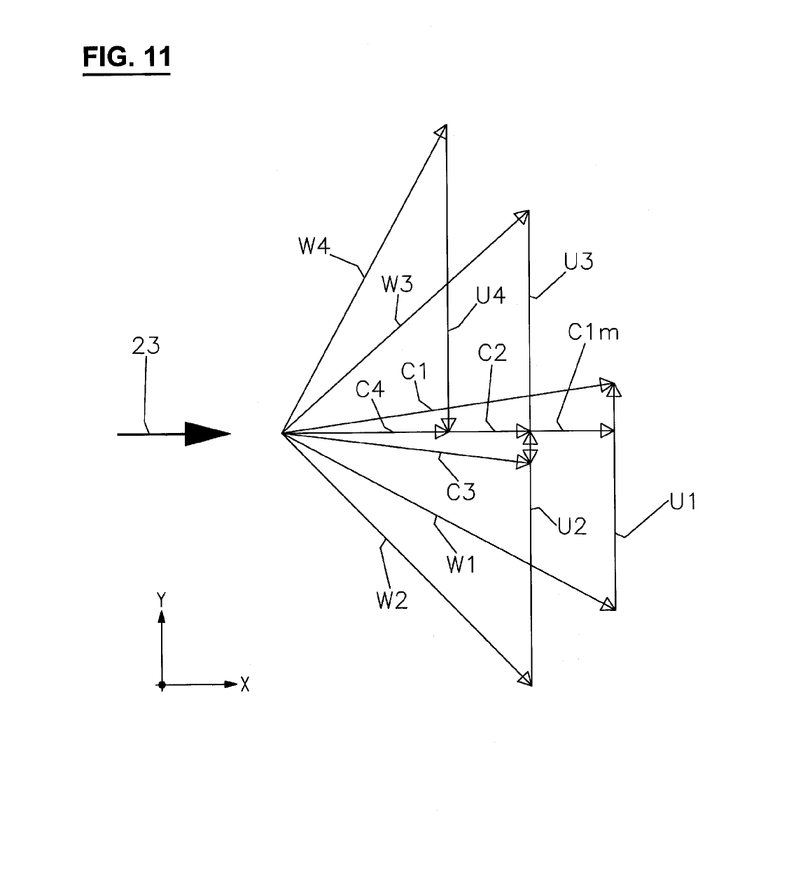

FIG. 11 is a vector diagram illustrating the absolute velocity, the relative velocity and the blade speed at four different positions of the wheels in the turbine shown in FIG. 2-4.

FIG. 1 schematically shows a partial view of a conventional hydroelectric power plant. It comprises a water intake passage 2 having its inlet protected by a bar screen 5. A screen washing system, not shown, is also provided to avoid clogging-up of bar screen 5. Water intake passage 2 generally has a convergent shape which guides the water towards a wheel 3 of a turbine 4 of axis D. A distributor 6 is provided in water intake passage 2 upstream of turbine 4 to properly direct the water flow with respect to blades 7 of wheel 3 of turbine 4. Turbine 4 of hydroelectric power plant generally is a Kaplan turbine, which has the shape of a helix and which generally comprises adjustable blades 7. A draft tube 8 guides the water from the outlet of turbine 4 towards a tail race 9. Turbine 4 can be stopped by means of the closing of distributor 6 generally equipped with movable wicket gates.

In the example of FIG. 1, axis D of turbine 4 is substantially horizontal, but it can also be a vertical. The electric generator (not shown) is arranged in a bulb-shaped carter 1 placed in the flow. It can also be placed outside the flow.

A Kaplan-type turbine generally has an optimal efficiency for a specific rotation speed of wheel 3. Water intake passage 2 aims at accelerating the water flow up to a velocity adapted to the optimal efficiency rotation speed of wheel 3. The velocity of the water coming out of wheel 3 is higher than the flow velocity upstream of hydroelectric power plant. Draft tube 8 aims at slowing down the flow coming out of wheel 3 and thus enables recovering as much of the kinetic energy remaining in the flow coming out of turbine 4 as possible. Normally the draft tube 8 length is greater than 4.6 times of the diameter of wheel 3.

Generally, a ratio K characterizing turbine 4 of a given hydroelectric power plant type is defined, corresponding to the ratio between the kinetic energy of the flow coming out of wheel 3 and the potential energy of the head. Ratio K, expressed in %, is given by the following relation:

K=100*V²/2gH

where V is the average speed of the flow coming out of wheel 3, g is the gravitation constant and H the head height. Ratio K is representative of the energy still contained in the flow in kinetic form when coming out of wheel 3, divided by the energy available for the turbine, and is thus representative of the energy to be recovered by draft tube 8.

The higher the ratio K, the greater the slowing down is to be performed. For conventional low-head Kaplan turbines, Mr. Joachim Raabe, in its work entitled “Hydro Power”, indicates that ratio K is 30%, 50%, and 80% for 70-meter, 15-meter, and 2-meter heads, respectively. The high kinetic energy to be recovered in very low head turbines at the outlet of wheel 3 leads to a construction of very large draft tubes since their divergence is limited by risks of separation of the liquid vein.

The forming of water intake passage 2 and of draft tube 8 of a hydroelectric power plant thus requires the forming of large civil engineering constructions. The very high cost of such constructions considerably burdens the total cost of the plant and has strongly limited the construction of hydroelectric power plants on low heads and very low heads for which the coefficient K is particularly high.

A counter rotating double turbine according to the invention, as further described below, can especially be used efficiently as an extreme low head turbine. The main problem in known Kaplan turbines is that with low heads the turbine diameter grows rapidly. For example ˜35 kW Turbine power can been reached with a flow of Q=1 m³/s and a head of H=4 m, or Q=4 m³/s and H=1 m, but at the same time the regular Kaplan turbine diameter grows from ˜47 cm to −133 cm. Or with a turbine power of just ˜9 kW with Q=1 m³/s and H=1 m it grows to a diameter of ˜67 cm. The reason for increasing the turbine diameter is to reduce the water speed and thus cavitations on turbine. With the counter rotating double turbine according to the invention it is possible to reduce the diameter to ⅔-¾ from the original size.

As the turbine diameter is the main factor which regulates also all the surrounding structures it is the key dimension which determines if the waterpower-project is even feasible. Normally civil work cost is found out to be 5 times higher under 1.5 m head as compared to under 3 m head. In very low heads the turbine diameter easily exceeds the head height and leads to a situation where the whole turbine must be rearranged as shown in Patent CA Pat. No. 2,546,508, or the problem is solved with a matrix of turbines as shown in U.S. Pat. No. 6,281,597.

Another known problem in existing Kaplan- and Francis-type water turbines is that their efficiency curve drops relatively rapidly when the flow is not in the planned optimum. This phenomenon can be reduced with variable pitch propellers and wicket gates, but it also increases the investing costs and such a system needs also constant process surveillance. As the invention described here is not based on an optimally developed vortex like water flow, i.e. the water flow as in a conventional Kaplan turbine, but instead an axially symmetric water flow, its efficiency-curve is less reliant to the optimum water flow. This gives the invention a benefit where great flow-variances occur.

As schematically indicated in FIG. 2, in accordance with the present invention, there is provided a water turbine comprised of the following components: two propeller-type turbine wheels 11, 12 in a flow tube 10 rotating in counter directions. The turbines are driveable connected together with a gear to synchronize their movements. The gear transfers the mechanical energy outside the water flow tube where it is turned into an electric energy.

FIG. 3 is a perspective view of a turbine 17 according to the invention. The turbine 20 comprises a water flow tube 18 with a substantially cylindrical outer wall 19. A flowing water with a flow direction 23 is fed into flow tube 21 at an upstream tube end 24. Flow tube 18 is composed of an entry tube section 20 beginning at upstream tube end 24, an intermediate turbine tube section 21, and a subsequent draft tube section 22 leading to an downstream tube end 25.

Entry tube section 20 is provided with an inner wall 26 with an inner diameter decreasing in the flow direction 23 in order to increase the kinetic energy of the flowing water. Turbine tube section 21 is provided with an inner wall 27 with an inner diameter increasing in the flow direction 23, for the reasons further explained below. Thus, the kinetic energy of the flowing water is already decreased in the turbine tube section 21. Draft tube section 22 is provided with an inner wall 28 with an inner diameter further increasing in the flow direction 23 in order to further decrease the kinetic energy of the flowing water to an upstream energy level before it enters into flow tube 18.

With respect to water flow direction 23, first a fore wheel 31 and subsequently an after wheel 32 are arranged inside turbine tube section 21 in immediate proximity to each other such that wheels 31, 32 can rotate along a common rotation axis 30 extending in water flow direction 23. Wheels 31, 32 are from the type of the wheels of a propeller turbine. It is also conceivable, however, that wheels 31, 32 are from the type of the wheels of a Kaplan turbine.

Wheels 31, 32 are each composed of a hub 33, 34 and several blades 35, 36. Blades 35, 36 are formed such that wheels 31, 32 rotate counterwise, i.e. in a mutually opposite rotation direction, driven by the water flow in direction 23. Fore wheel 31 has four blades 35 and after wheel 32 has three blades 36. The shape of the outer edge 37, 38 of blades 35, 36 is adapted to the geometry of inner wall 27 of turbine tube section 21, such that blades 35, 36 can rotate in immediate proximity to inner wall 27 of turbine tube section 21.

The position at which the water flow enters wheels 31, 32 is subsequently denoted as the respective leading edge 39, 40 of wheels 31, 32. The position at which the water flow exits wheels 31, 32 is subsequently denoted as the respective leaving edge 41, 42 of wheels 31, 32. The diameter of leaving edge 41 of fore wheel 31 corresponds to the diameter of leading edge 40 of after wheel 32. Turbine tube section 21 ends at leaving edge 42 of after wheel 32, at which draft tube section 22 follows. At leading edge 39 of fore wheel 31, a hydrodynamic nose structure 29 is provided as an upstream extension of hub 33 to improve the fluid dynamics. The length of draft tube section 22 corresponds to approximately three times of the leading edge diameter 39 of fore wheel 31.

Inside draft tube section 22, i.e. further downstream with respect to leaving edge 42 of after wheel 32, a gear arrangement 45 is provided. Gear arrangement 45 comprises a first gear 46 and a second gear 47 subsequently arranged around rotation axis 30 in a mutually opposing manner such that gears 46, 47 are facing each other. Gears 46, 47 are conical gears. An engagement gearing 48 facing rotation axis 30 is provided above rotation axis 30 in such a manner, that it engages with both other gears 46, 47. For this purpose, first gear 46 and second gear 47 are arranged on the downstream and upstream end of engagement gearing 48, respectively. Engagement gearing 48 is constituted by a conical gear. Wheels 31, 32 are connected to gears 46, 47 each via a respective shaft 56, 57, as further explained below.

At its outer surface, engagement gearing 48 is fixed to a transmission shaft 51. Transmission shaft 51 extends from engagement gearing 48 orthogonally to outer wall 19 to a region outside of flow tube 18. For this purpose, a through hole 52 is provided in outer wall 19 of flow tube 18. Around the position of through hole 52, a mounting block 53 is provided by which an outer cylinder 54 is fixed on outer wall 19. Transmission shaft 51 extends along the central axis of outer cylinder 54 to its upper end, where transmission shaft 51 is provided with a driving crank 55. Driving crank 55 or transmission shaft 51 is connected to a power generator to produce electrical energy. The generator can be installed, for instance, inside or above or in place of outer cylinder 54.

From FIG. 4 depicting a detailed sectional view of turbine 17 it is apparent that fore wheel 31 is connected to first gear 46 via first shaft 56 and after wheel 32 is connected to second gear 47 via second shaft 57. The respective gears 46, 47 are arranged inversely with respect to water flow direction 23 as compared to fore wheel 31 and after wheel 32, i.e. first gear 46 is arranged after second gear 47 along rotational axis 30.

Shafts 56, 57 extend along rotation axis 30. Second shaft 57 is a hollow shaft through which first shaft 56 concentrically extends. Via shafts 56, 57, gears 46, 47 are driven to rotate in the same direction as respective wheels 31, 32 driven by the water flow. Thus, a counterwise rotation of gears 46, 47 is achieved through the water flow, such that gears 46, 47 rotate in a mutually opposite direction, which is necessary to drive engagement gearing 48. Moreover, an equivalent rotation speed of gears 46, 47 is intrinsic for the drive of engagement gearing 48. In this way, the rotation speeds of wheels 31, 32 are mutually coupled by means of engagement gearing 48. To provide the rotation speeds of wheels 31, 32 at the desired equivalent value, the geometry of turbine tube section 21 and wheels 31, 32 is adjusted accordingly.

It becomes further apparent from FIG. 4, that inner wall 27 of turbine tube section 21 exhibits a convex curvature along which the cross-sectional area of turbine tube section 21 widens in water flow direction 23. Thus, the inner diameter of turbine tube section 21 increases with an increasing slope and a flow profile of inner wall 27 is provided along which the mean fluid velocity decelerates. The convex curvature of inner wall 27 extends from a position with a forward distance to leading edge 39 of fore wheel 31 to the position of leaving edge 42 of after wheel 32. This geometry is used to synchronize the rotation speed of wheels 31, 32.

Draft tube section 22 following turbine tube section 21 after the position of leaving edge 42 of after wheel 32 has a diameter further increasing in water flow direction 23. The shape of inner wall 28 of draft tube section 22 exhibits a slightly concave curvature or a substantially constant slope. The geometry and length of inner wall 28 of draft tube section 22 is designed for recovery of the kinetic energy of the water flow. Nonetheless, also the geometry of inner wall 27 of turbine tube section 21—together with the inner arrangement of wheels 31, 32—largely contributes to the recovery of kinetic energy. This leads to an effective reduction of the length required for draft tube section 28.

FIG. 5 shows a frontal view of fore wheel 31. Fore wheel 31 comprises four blades 35a-35d with an identical shape and equidistantly arranged around hub 33.

FIG. 6 shows a frontal view of after wheel 32. After wheel 32 comprises three blades 36a-36c with an identical shape and equidistantly arranged around hub 34. Blades 36a-36c have a larger surface as compared to blades 35a-35d. The diameter of fore wheel 31 at its leaving edge 41 substantially corresponds to the diameter of after wheel 32 it its leading edge 40. The diameter of fore wheel 31 at its leading edge 39 deviates from the diameter of after wheel 32 it its leaving edge 42 by approximately 25% to 30%.

FIG. 7 shows a side view of fore wheel 31. In the figure, a blade angle α in between outer edge 37 of blades 35 and a plane 61 orthogonal to rotation axis 30 is indicated. Blade angle α varies with the longitudinal position of orthogonal plane 61 along rotation axis 30. This longitudinal variation of blade angle α is affected by the course 58 of blades 35 along which blades 35 extend around hub 33, by the desired rotation direction of fore wheel 31 driven by water flow 23 and by the shape of inner wall 27 of turbine tube section 21 such that outer edges 37 of blades 35 seamlessly border onto inner wall 27. Course 58 of blades 35 along hub 33 can be described as a partial helix winding around hub 33, as further described below.

FIG. 8 depicts a corresponding side view of after wheel 32, in which blade angle β in between outer edge 38 of blades 36 with respect to plane 61 orthogonal to rotation axis 30 is indicated. Blade angle β also exhibits a longitudinal variation, the amount of which being affected by the course 59 of blades 36 along hub 34, by the desired rotation direction of after wheel 32 driven by water flow 23 and by the shape of inner wall 27 of turbine tube section 21 such that outer edges 38 of blades 36 seamlessly border onto inner wall 27. Course 59 of blades 36 can be described as a continuation of the partial helix winding along course 58 around hub 33. The helical course 58, 59 of blades 35, 36 around hubs 33, 34 of wheels 31, 32 is subsequently described in greater detail on the basis of a schematic illustration shown in FIGS. 9 and 10.

The length of after wheel 32 in water flow direction 23 along which blades 36 extend exceeds the corresponding length of fore wheel 31 along which blades 35 extend. In this way, a desired pitch of the helical course 59 of blades 36 can be reached at leaving edge 42 of after wheel 32. The blade geometry allows to compensate for the chosen lower number of blades 36 on after wheel 32 as compared to the number of blades 35 on fore wheel 31 in order to synchronize the rotation speed of the wheels.

FIG. 9 schematically shows a frontal view through a cross-sectional area 63 inside turbine tube section 21 with a cylindrical body 66 at its center. Cylinder 66 extends along rotation axis 30. A helix 64 with a diameter increasing in water flow direction 23 winds around cylinder 66.

FIG. 10 shows a corresponding side view of cylinder 66 and helix 64. Cross-sectional areas 61 further upstream with respect to cross-sectional area 63 are also indicated. In addition, various flow lines 67, 68 of the water flow inside inner wall 27 of turbine tube section 21 are indicated. The distance between flow lines 67, 68 widens in water flow direction 23 with an increasing slope. Helix 64 winds around the most outer flow lines 68.

Cylinder 66 serves as a schematic illustration of hub 33 of fore wheel 31 or of hub 34 of after wheel 32 or of a combination of both hubs 33, 34 in which fore wheel 31 and after wheel 32 are directly arranged one after the other along water flow direction 23. Helix 64 serves to illustrate the corresponding shape of blades 35, 36 at the position of outer flow lines 68.

More precisely, helix 64 defines a pitch line, i.e. a line that passes through the leading edge 39, 40 and leaving edge 41, 42 of blades 35, 36 at the position of outer flow lines 68. The shape of blades 35, 36 changes accordingly at inner flow lines 67. As already noted, the length of courses 58, 59 of blades 35, 36 along hub 33, 34 of fore wheel 31 and after wheel 32 corresponds to a partial helical revolution around cylinder 66.

Three subsequent longitudinal distances P1, P2, P3 in flow direction 23 are indicated in FIG. 10, each corresponding to one revolution of helix 64. Longitudinal distances P1, P2, P3 of the helix revolutions decrease in flow direction 23. The corresponding radiuses R1, R2, R3, R4 of the respective helix revolutions increase in flow direction 23. Corresponding angles γ1, γ2, γ3 between helix 64 and cross-sectional areas 61 continuously decrease in flow direction 23.

Longitudinal distances P1, P2, P3 define the pitch of blades 35, 36 at outer flow lines 68. Pitch P1, P2, P3 is a measure of the axial fluctuation in motion of a given radial position R1, R2, R3, R4 that has been covered after one complete revolution of blades 35, 36. Radiuses R1, R2, R3, R4 are subsequently denoted as pitch radius. Angles γ1, γ2, γ3 define the pitch angle of blades 35, 36 at outer flow lines 68. Pitch angles γ1, γ2, γ3 are a measure of the pressure face of blades 35, 36 along pitch line 64 with respect to plane of rotation 61.

Accordingly, pitch P1, P2, P3 of blades 35, 36 of wheels 31, 32 shown in FIGS. 7 and 8 continuously decreases in water flow direction 23. Pitch radius R1, R2, R3, R4 of blades 35, 36 of wheels 31, 32 continuously increases in water flow direction 23. Pitch angle γ1, γ2, γ3 of blades 35, 36 of wheels 31, 32 continuously decreases in water flow direction 23.

In the vector diagram shown in FIG. 11, a specific example of the absolute velocity, relative velocity and blade speed at two different positions of fore wheel 11, 31 and at two different positions of after wheel 12, 32 is illustrated.

The absolute velocity C1 at leading edge 39 of fore wheel 31 is given by the sum of the relative velocity W1 and the blade speed U1 at leading edge 39 of fore wheel 31. The absolute velocity C2 at leaving edge 41 of fore wheel 31 is given by the sum of the relative velocity W2 and the blade speed U2 at leaving edge 41 of fore wheel 31. The absolute velocity C3 at leading edge 40 of after wheel 32 is given by the sum of relative velocity W3 and blade speed U3 at leading edge 40 of after wheel 32. The absolute velocity C4 at leaving edge 42 of after wheel 32 is given by the sum of the relative velocity W4 and the blade speed U4 at leaving edge 42 of after wheel 32. The vectors are designated in a Cartesian coordinate system with an axial vector component X in water flow direction 23 and a tangential vector component Y in an orthogonal direction.

Absolute velocities C1, C2, C3, C4 are a measure of the speed of the incoming water flow in an absolute frame of reference. C1m denotes the meridian velocity at leading edge 39 of fore wheel 31 averaged over the cross sectional area of the water flow. Blade speeds U1, U2, U3, U4 are a measure of the tangential velocity ω·r of blades 35, 36 at a radial distance r, when wheels 11, 12, 31, 32 rotate with rotation speed ω. Relative velocities W1, W2, W3, W4 are a measure of the speed of water flow in a frame of motion relative to blade speeds U1, U2, U3, U4. Thus, relative velocities W1, W2, W3, W4 are influenced by the respective angle of blades 35, 36 of wheels 11, 12, 31, 32 with respect to line 61 orthogonal to rotation axis 30.

In common axial turbines, such as in Kaplan, Francis or propeller turbines, the velocity of the passing water jet substantially remains unchanged and only the water pressure is changed as the water jet acts on the turbine blades. Such a type of turbine is also referred to as reaction turbine.

As depicted in FIG. 11, however, the velocity C1, C2, C3, C4 of a water jet changes during its passage of turbine tube section 21 of axial turbine 17. Turbine 17 according to the invention may therefore be regarded as an “axial impulse turbine” in which also a change of velocity of the water flow can be exploited for energy generation.

Moreover, the axial turbine loss during the water passage of the wheels and therefore the efficiency of axial turbines, in particular of current Kaplan, Francis or propeller type turbines, generally depends on approximately the square of the relative velocity W of the water flow relative to the blade speed. However, since relative velocity W1, W2, W3, W4 of a water jet passing through turbine tube section 21 according to the invention is strongly reduced due to the decrease of absolute velocity C1, C2, C3, C4, the efficiency of an axial turbine 17 according to the invention can be optimized.

Subsequently, several features of turbine 17 depicted in FIG. 3-8 and other embodiments and advantages of the invention are summarized:

The turbine drive depicted in FIG. 3 is designated to be directly mounted to the input shaft of a generator (not shown). The drive contains a reversing mechanism 45 which has a driving shaft 51 having a conical gear 48 in constant engagement with two conical gears 46 and 47. The gear 46 is driven by a propeller shaft 56 and the gear 47 is driven by a propeller shaft 57 in the form of a hollow shaft mounted concentrically to the shaft 56. The shaft 56 carries a propeller 31 and the shaft 57 a propeller 32. With the arrangement described, the propeller shafts will rotate in opposite directions. The shown arrangement can been placed after the propellers 31 and 32 as shown in FIG. 3 or it can been placed before the propellers 31, 32.

The after propeller 32 has a greater diameter than the fore propeller 31, and the flow tube 10, 18 must be formed, as schematically illustrated in FIGS. 2 and 4, so that both propellers can function efficiently and an axially symmetric water flow can been maintained with a maximum water velocity and pressure reduction on the propellers 31, 32.

As water speed can be efficiently lowered already in the turbine 17 itself, it means also that the optimal draft tube 22 relative length is smaller than it is with regular turbines. The flow tube 10, 18 can been build up tube as in the embodiment shown in FIG. 2-4, or it can been a virtual tube in free water just describing the flow.

In the embodiment shown in FIG. 2-8, the diameter of the fore propeller 31 is 93% of the diameter of the after propeller 32, but depending on various factors such as head height and flow for example, the diameter of the fore propeller 31 can be also 80-97% or 60-97% or beyond of the diameter of the after propeller 32. The fore propeller 31 can have the same or greater pitch than the after propeller 32.

The fore propeller has more blades 35 (i.e. 4 pcs), while the after propeller has less blades 36 (i.e. 3 pcs), as shown in the embodiment in FIG. 2-8.

As shown in the embodiment in FIG. 2-8, the propellers leading edge has a smaller diameter than the leaving edge. This helps the turbine to reach the optimum flow tube form 10 shown in FIG. 2-4.

The propellers 31, 32 pitch P1, P2, P3 may also vary in the blade area if there is also a difference on blade edge diameters.

From the foregoing description, numerous modifications of the turbine according to the invention and to a corresponding hydroelectric power plant are apparent to one skilled in the art without leaving the scope of protection of the invention that is solely defined by the claims.

1. A turbine for hydraulic power generation comprising two bladed wheels successively arranged in a turbine tube section as a fore wheel and an after wheel with respect to the water flow direction along a common rotation axis extending in the water flow direction, the wheels being configured to rotate in opposite directions driven by the water flow, wherein a first gear and a second gear are arranged along the rotation axis, wherein the first gear is connected to the fore wheel and the second gear is connected to the after wheel such that each of the first and second gear is configured to rotate around the rotation axis driven by the respective wheel, and the first gear and the second gear are connected via an engagement gearing such that the fore wheel and the after wheel are coupled to each other with respect to their rotation speed, the engagement gearing being connectable to a power generator.

2. The turbine according to claim 1, wherein the first gear is connected to the fore wheel via a first shaft and the second gear is connected to the after wheel via a second shaft, one of the shafts being a hollow shaft and the other shaft extending concentrically through the hollow shaft along the rotation axis.

3. The turbine according to claim 1, wherein the engagement gearing is fixed to a transmission shaft for connecting the engagement gearing to a power generator, the transmission shaft extending through an outer wall of the turbine tube section or of a tube section before or behind the turbine tube section.

4. The turbine according to claim 1, wherein the geometry of the turbine tube section and/or the wheels is adapted such that the fore wheel and the after wheel are configured to be driven by the water flow at substantially the same rotation speed.

5. The turbine according to claim 1, wherein the turbine tube section is provided with an inside diameter increasing in the water flow direction.

6. The turbine according to claim 5, wherein the inside diameter of the turbine tube section increases with a slope continuously increasing from the position at which the water flow enters the fore wheel to the position at which the water flow exits the after wheel.

7. The turbine according to claim 5, wherein the change of the inside diameter of the turbine tube section is chosen such that the water flow speed is reduced by at least 6%, more preferred by at least 20%, at the cross-sectional area at which the water flow exits the after wheel as compared to the cross-sectional area at which the water flow enters the fore wheel.

8. The turbine according to claim 1, wherein the fore wheel or the after wheel or both have a diameter at a leading edge at which the water flow enters the wheel which is smaller as compared to the diameter at a leaving edge at which the water flow exits the respective wheel.

9. The turbine according to claim 8, wherein the difference between the leaving edge diameter and the leading edge diameter of the after wheel is larger as compared to the difference between the leaving edge diameter and the leading edge diameter of the fore wheel.

10. The turbine according to claim 1, wherein the leading edge diameter of the fore wheel at which the water flow enters the fore wheel is at most 97%, more preferred at most 90% and most preferred at most 80%, of the leaving edge diameter of the after wheel at which the water flow exits the after wheel.

11. The turbine according to claim 1, wherein the fore wheel and the after wheel are arranged in immediate proximity to each other.

12. The turbine according to claim 1, wherein the length in the water flow direction of the after wheel is different as compared to the length in the water flow direction of the fore wheel.

13. The turbine according to claim 1, wherein the pitch of the wheel blades decreases in the water flow direction.

14. The turbine according to claim 13, wherein the corresponding radius of the pitch of the wheel blades increases in the water flow direction.

15. The turbine according to claim 1, wherein the wheels are arranged along the rotation axis before or after the gears with respect to the water flow direction.

16. The turbine according to claim 1, wherein a different number of blades is provided on the fore wheel as compared to the after wheel.

17. The turbine according to claim 1, wherein at a position at which the water flow exits the after wheel the turbine tube section is followed by a draft tube section, the draft tube section being provided with an inside diameter increasing in the water flow direction and a length adapted to recover the water flow speed downstream of the turbine to a level of the water flow speed upstream of the turbine.

18. The turbine according to claim 17, wherein the length of the draft tube section corresponds to a value of at most four times the diameter of the fore wheel at a leading edge at which the water flow enters the wheel.

19. A hydroelectric power plant comprising a flowing or falling water and at least one turbine according to claim 1, wherein the flowing or falling water is channeled through the turbine tube section.

20. The hydroelectric power plant according to claim 19, wherein the flowing or falling water exhibits a hydraulic head of at most 4 m, more preferred at most 2.5 m and most preferred at most 0.8 m, before entering the turbine tube section.
